(19) United States
(12) Patent Application Publication
(10) Pub. No.: US 2006/0219072 A1
(43) Pub. Date: Oct. 5, 2006

(54) Web cutting device

(76) Inventors: Topi Tynkkynen, Vantaa (FI); Tatu Pitkanen, Jarvenpaa (FI); Raimo Pesonen, Vantaa (FI); Kalevi Vesterinen, Vantaa (FI); Teppo Kojo, Mantsala (FI); Petteri Lannes, Jokela (FI)

Correspondence Address: STIENNON & STIENNON, 612 W. MAIN ST., SUITE 201, P.O. BOX 1667, MADISON, WI, 53701-1667, US

(21) Appl. No.: 11/392,008

(22) Filed: Mar. 29, 2006

(30) Foreign Application Priority Data
Mar. 31, 2005 (FI) U20050105

(51) Int. Cl. B26D 3/00; B26F 3/00

(52) U.S. Cl. 83/177; 83/53

(57) ABSTRACT

A device for cutting a web with at least two cutting members for cutting/cross-cutting the web in the cross-direction and producing a cross-cut. The cutting members having a common actuator which moves the cutting members in directions apposite to each other in the cross-direction of the web.

### CROSS REFERENCES TO RELATED APPLICATIONS

This application claims priority on Finnish Application No. U20050105, Filed Mar. 31, 2005, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to a web cutting device. The present invention relates especially to the cutting/cross-cutting of a web taking place in connection with the reeling of a fibre web, such as a paper or board web, when the reeling of the web is changed from a full roll to a new roll. The invention also relates to the web cutting/cross-cutting of a web, a fibre web, for example, a paper or board web, taking place in connection with web threading, in which a leader strip is cut from a full-width web, which leader strip is fed through the machine or part of the machine, after which the web is spread to full width.

In continuous fibre-web machines, such as paper or board machines or their coating machines, when a machine roll already wound on a reel-up becomes full or of desired size, the web is turned up from a full roll onto a new roll at the full operating speed of the machine. In such a case, reliability in operation is required of the cutting/cross-cutting of the web and of its turnup to wind it into a new roll in order that it shall not be necessary to interrupt the operation. As known from prior art, inter alia, different water cutting devices have been used in cutting the web. In addition, known from prior art is the use of laser-based cutting devices and different knives and blows.

With respect to prior art, reference is made to, for example, FI patent 113258; EP patent application 1022381, U.S. Pat. No. 5,360,179; EP patent application 0067051; WO application publication 92/06913; and US Pat. No. 6,508,429, which describe different web-cutting methods mostly related to water cutting applications.

In known methods, in connection with the turnup process the cutting of the web is most commonly accomplished so that the cutting of the web is started in the cross-direction of the web from its middle area, and the web is cut with two nozzle units or corresponding cutting members proceeding from the middle to the edges.

A problem of web-cutting devices known from prior art, especially of water cutting devices, has been that two nozzle units are usually used in cutting, which units cut a wedge-shaped tip in the web starting from the middle of the web and proceeding to the web edges, both nozzle units being provided with their own actuators, which means that the device has had high costs.

### SUMMARY OF THE INVENTION

The object of the invention is to provide a device for cutting a web, in which device the above-mentioned disadvantages associated with devices known from prior art have been eliminated or at least minimised.

The object of the invention is especially to provide a device which is cost-effective, reliable in operation, and space-saving.

The device for cutting/cross-cutting a web according to the invention has at least two cutting members, for example, high-pressure water nozzles, laser-cutting members or cutting knives arranged in the device so that, in the cutting situation, power is transmitted with one actuator to both/each cutting member so that the cutting members move in the cross-direction of the web, for example, from the middle of the web towards the edges, that is, in directions opposite to each other, for example, in a mirror image-like manner, when the actuator is operated. Then, considerable advantages are achieved, because a smaller number of components are required for the device, its operation is more reliable when one actuator operates both nozzle units. In addition, need for maintenance is reduced, and obviously, manufacturing costs are lower. Furthermore, the device takes considerably less space in the running direction of the web (machine direction) than arrangements known from prior art.

According to one application of the invention, the web cutting device is implemented so that it comprises two cutting members, for example, high-pressure water nozzles, which are fastened to the same toothed belt, on the different sides of belt rotating pulleys, so that when the belt is moved via a drive, the cutting members move in opposite directions. In this advantageous embodiment of the invention, the belt may be in the vertical or horizontal direction in relation to the web level.

According to another embodiment of the invention, in order to move the two cutting members in different directions, a ball-race screw is used as the actuator of the cutting device, which screw is fast and accurate, for the driving power of which it is possible to use pressurized air, a hydraulic fluid or a hydraulic motor or an electric motor, and if needed, the drive may be provided with a clutch, so that, for example, the electric motor may be accelerated to the operating speed already before connecting it to the ball-race screw. The ball-race screw is provided with a bidirectional thread extending from the middle of the screw to the ends of the screw, the cutting members to be moved being placed on the thread such that, when the ball-race screw is operated with the motor, the nozzle units start to move on the ball-race screw in opposite directions from the middle of the ball-race screw to its edges or from the edges to the middle.

According to the invention, the cutting members may also be placed in an arrangement in which a device producing a pressure is placed between the cutting members, which pressure is produced, for example, by gasifying some material, such as gunpowder, or by a small pump unit, for example, a pump nozzle, or by heating liquid and gas, in which case the expansion of the material in the combustion space provides pressure in order to move the nozzles, for example, via a piston, whereby the cutting members start to move in the opposite directions.

According to the invention, the cutting of the web may be accomplished as water, knife or laser cutting according to the aforementioned embodiments via one actuator.

The device according to the invention may also be implemented in connection with cutting units moved in place by turning with one actuator mechanically or optically, and the cutting energy is advantageously provided, for example, directly with electricity. In that case, the cutting members are placed in the device so that they are pivoted, which means that the actuator is used for producing a rotating movement around the pivot mechanically or optically by means of a directing mechanism of a cutting beam, thus enabling the web to be cut.

The device for cutting/cross-cutting a web according to the invention is applicable for use, for example, in the web cutting taking place in connection with the reeling of the fibre web, when the reeling of the web is changed from a full roll to a new roll and when a leader strip is cut from a full-width web, which leader strip is passed through the machine and spread to the edges.

When using an embodiment of the invention comprising more than two cutting members, an extremely quick web cross-cutting operation is achieved.

In the different embodiments of the invention, the cutting marks produced with the cutting members may coincide with each other/cut each other or a small strip may remain between them.

The invention will now be described in more detail with reference to the figures of the accompanying drawing, but the invention is by no means meant to be narrowly limited to the details of the figures.

### BRIEF DESCRIPTION OF THE DRAWINGS

FIG. 1 schematically shows an embodiment of the invention in which a toothed belt and belt pulleys are used as the actuator of the device.

FIGS. 2A and 2B schematically show two different embodiments of the device shown in FIG. 1.

FIG. 3 schematically shows an embodiment of the invention based on a ball-race screw.

FIG. 4 schematically shows an embodiment of the invention based on producing a volume flow/pressure in order to move cutting members.

FIG. 5 schematically shows an embodiment of the invention in which a cutting member is turned around a pivot.

### DESCRIPTION OF THE PREFERRED EMBODIMENTS

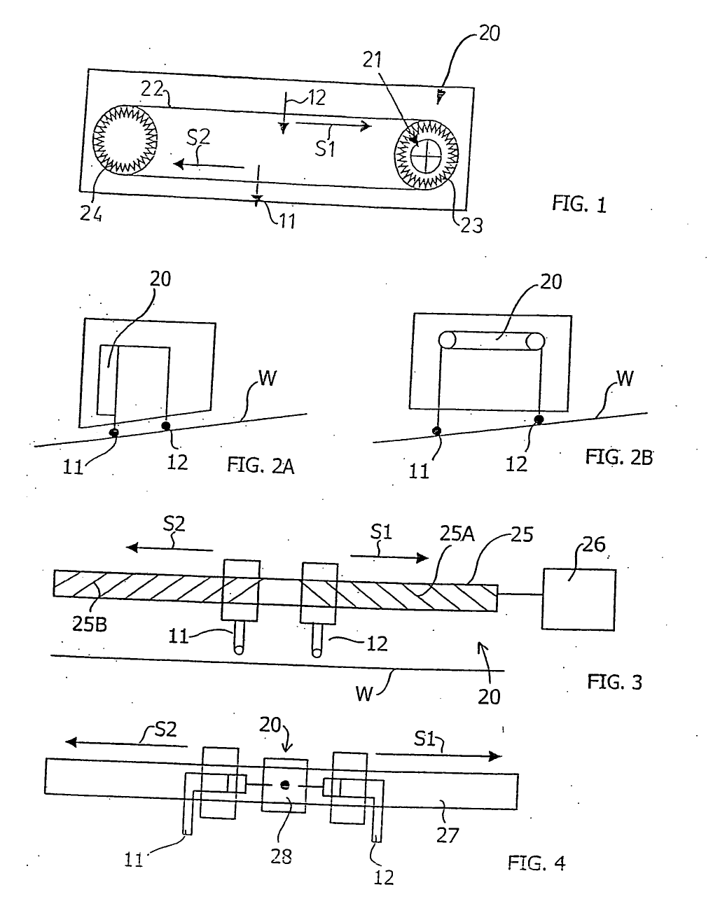

FIG. 1 depicts an embodiment relating to a water cutting device which has two high-pressure water nozzles 11, 12 fastened to the same toothed belt 22, to the different sides of pulleys 23, 24 rotating the belt 22, the nozzles 11, 12 moving in opposite directions S1, S2 in the cross-direction of the web when the belt 22 is moved via a drive 21.

FIG. 2A schematically shows an arrangement of the embodiment shown in FIG. 1, placed so that a common actuator 20 for the nozzles 11, 12 is placed in the vertical position in relation to the web W.

FIG. 2B schematically shows an arrangement of the embodiment shown in FIG. 1 so that the common actuator 20 for the nozzles 11, 12 is placed in the horizontal direction in relation to the web W.

FIG. 3 schematically shows an embodiment of the invention in which the cutting members 11, 12 are placed on a ball-race screw 25 such that threads 25A, 25B of the ball-race screw 25 go in different directions, so that when turning the ball-race screw 25 via a motor 26, the cutting members 11, 12 move in different directions S1, S2.

The embodiment of the invention shown in FIG. 4 is based on an arrangement 27 in which the actuator provides the movement of the cutting members 11, 12 in different directions by means of producing a volume flow/pressure, the pressure being produced with the actuator 20 in its unit 28, for example, by gasifying some material, by a small pump unit or by heating liquid/gas, in which case the change of pressure/volume causes the cutting members 11, 12 to move away from the unit 28 in opposite directions S1 and S2.

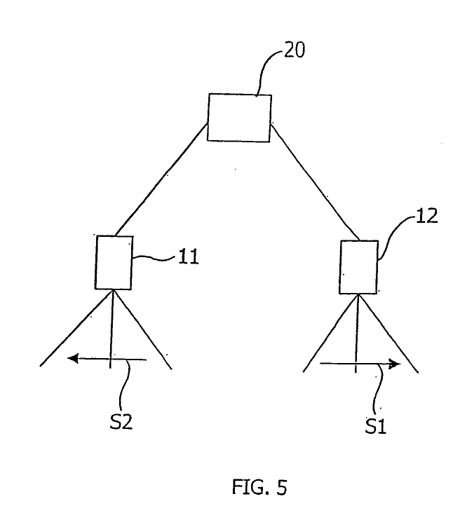

FIG. 5 schematically shows an embodiment in which the cutting members 11, 12 are placed on pivots, the pivots being rotated with the actuator 20 so that the cutting members 11, 12 turn in different directions S1, S2 and cut the web W.

The invention also naturally encompasses embodiments in which cutting is performed reversely to the afore-mentioned embodiments, from the edges towards the middle, and, naturally, embodiments which use more than two cutting members, in which case, of course, some of the cutting members move in the same direction and some in the opposite direction, this kind of embodiment being especially useful, for example, in situations in which the web is desired to be cut very quickly.

Obviously, when cutting the web, the cutting marks of the different cutting members may also cross one another depending on the embodiment, or a small strip may remain between the cutting marks, which strip is cut in another suitable manner or it breaks by itself.

The invention has been described above only with reference to some of its advantageous embodiments, to the details of which the invention is, however, by no means intended to be narrowly limited.

We claim:

1. A device for cutting a web, comprising:
a first cutting member mounted for motion in a cross-direction;
a second cutting member mounted for motion in the cross-direction;
a ball-race screw having a first thread, and a second thread going in opposite directions in the cross-direction, the first cutting member mounted for motion to the first thread and the second cutting member mounted for motion to the second thread; and
a drive connected to turn the ball-race screw so as to move the first cutting member and the second cutting member in opposite directions in the cross-direction of the web.

2. A device for cutting a web, comprising:
a first cutting member mounted for motion in a cross-direction;
a second cutting member mounted for motion in the cross-direction; and
an actuator which operates by a change in a fluid, volume flow or pressure, by which change the first cutting member and the second cutting member are arranged to be moved in relation to each other in opposite directions.

3. A device for cutting a web having a middle and two edges, comprising:
a first cutting member pivotally mounted for rotation;
a second cutting member pivotally mounted for rotation; and
a common actuator fastened to the first cutting member and the second cutting member so that the actuation of the common actuator causes the cutting members to turn in different directions, so that a cut extending from the middle to the edges of the web is formed.
